(19) United States
(12) Patent Application Publication
(10) Pub. No.: US 2016/0210703 A1
(43) Pub. Date: Jul. 21, 2016

(54) VIRTUAL CAREER COUNSELOR

(71) Applicant: LinkedIn Corporation, Mountain View, CA (US)

(72) Inventors: Mudit Goel, Sunnyvale, CA (US); Ravneet Singh Khalsa, Hayward, CA (US)

(21) Appl. No.: 14/600,538

(22) Filed: Jan. 20, 2015

(51) Int. Cl. G06Q 50/00; G06Q 10/00

(52) U.S. Cl. CPC G06Q 50/01; G06Q 10/00

(57) ABSTRACT

In systems, methods, and machine readable media for recommending a next career position to a user of a social network system, the user may identify a goal position through a user interface. For instance, the goal position may represent a job that the user wishes to have at some future time, an entry-level job in a new field for the user, or a desired college degree. The system may select role models from the full membership of the social network system, where each role model has held or currently holds the goal career position, and where each role model may optionally have once held the current position of the user. The system may aggregate the career histories of the role models to determine a recommended next career position for the user. The system may display the recommendation, along with other suitable data, through the user interface to the user.

### BACKGROUND

A social network system is a computer or web-based service that enables users to establish links or connections with persons for the purpose of sharing information with one another. Some social network systems aim to enable friends and family to communicate and share with one another, while others are specifically directed to business users with a goal of establishing professional networks and sharing business information. For purposes of the present disclosure, the terms “social network” and “social network system” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 is a block diagram illustrating various components of a social network system with a recommendation engine for recommending a next career position to a user of the social network system, in accordance with some examples.

FIG. 2 shows an example of a recommendation engine for recommending a next career position to a user of a social network system, in accordance with some examples.

FIG. 3 shows an example of a method for recommending a next career position to a user of a social network system, in accordance with some examples.

FIG. 4 shows a diagram of a social network system in accordance with some examples.

FIG. 5 illustrates a block diagram of an example machine upon which any one or more of the techniques (e.g., methodologies) discussed herein may perform.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business network system. The present inventive subject matter is generally applicable to a wide range of information services.

A social network system is a service provided by one or more computer systems accessible over a network that allows members of the service to build or reflect social networks or social relations among members. Typically, members construct profiles, which may include personal information such as the member's name, contact information, employment information, photographs, personal messages, status information, multimedia, links to web-related content, blogs, and so on. In order to build or reflect these social networks or social relations among members, the social network system allows members to identify, and establish links or connections with other members. For instance, in the context of a business network system (a type of social network system), a person may establish a link or connection with his or her business contacts, including work colleagues, clients, customers, personal contacts, and so on. With a social network system, a person may establish links or connections with his or her friends, family, or business contacts. While a social network system and a business network system may be generally described in terms of typical use cases (e.g., for personal and business networking, respectively), it will be understood by one of ordinary skill in the art that a business network system may be used for personal purposes (e.g., connecting with friends, classmates, former classmates, and the like) as well as or instead of business networking purposes and a social network system may likewise be used for business networking purposes as well as or in place of social networking purposes. A connection may be formed using an invitation process in which one member invites a second member to form a link. The second member then has the option of accepting or declining the invitation.

In general, a connection or link represents or is otherwise associated with an information access privilege, such that a first person who has established a connection with a second person is, via the establishment of that connection, authorizing the second person to view or access certain non-publicly available portions of their profiles that may include communications they have authored. Example communications may include blog posts, messages, wall postings, or the like. Depending on the particular implementation of the business/social network system, the nature and type of the information that may be shared, as well as the granularity with which the access privileges may be defined to protect certain types of data, may vary greatly.

Some social network systems may offer a subscription or following process to create a connection instead of or in addition to the invitation process. A subscription or following model is where one member follows another member without the need for mutual agreement. Typically in this model, the follower is notified of public messages and other communications posted by the member that is followed. An example social network system that follows this model is Twitter®, which is a micro-blogging service that allows members to follow other members without explicit permission. Other, connection based social network systems also may allow following type relationships as well. For example, the social network system LinkedIn® allows members to follow particular companies.

Some social network systems can track the careers of their members. For instance, when a user signs up to be a member of a social network system, the user can enter details pertinent to the user's work history, such as college degrees, job positions or titles, beginning and end dates for the particular job positions, skill sets, and the like. The social network system can store these work-oriented details in a suitable database. Using these work-oriented details can be very useful for a user when the user wishes to change jobs or career paths.

In some examples, a member of a social network system can rely on connections within the social network system for career advice. There can be obstacles to using connections for career advice. For instance, a member may not have many connections at career positions significantly higher than the member. As a result, the member may receive advice from a relatively small number of connections. Such advice may be subject to the connections' bias, or may not include information outside the particular career paths of the connections. The methods, systems, and non-transitory machine-readable media discussed herein can overcome such obstacles by using career histories culled from the full membership of the social network system to generate career advice, rather than just relying on direct connections.

Disclosed in some examples are systems, methods, and machine readable media for recommending a next career position to a user of a social network system. The user may identify a goal position through a user interface. For instance, the goal position may represent a job that the user wishes to have at some future time, an entry-level job in a new field for the user, or a desired college degree. The system may select role models from the full membership of the social network system, where each role model has held or currently holds the goal career position, and where each role model may optionally have once held the current position of the user. The system may aggregate the career histories of the role models to determine a recommended next career position for the user. For instance, if a user has a current position of Programmer and a goal position of Chief Operating Officer, and a relatively high percentage of the role models moved from Programmer to Senior Programmer on their way to becoming Chief Operating Officer, then the system may recommend a next position of Senior Programmer to the user. The system may display the recommendation, along with other suitable data, through the user interface to the user.

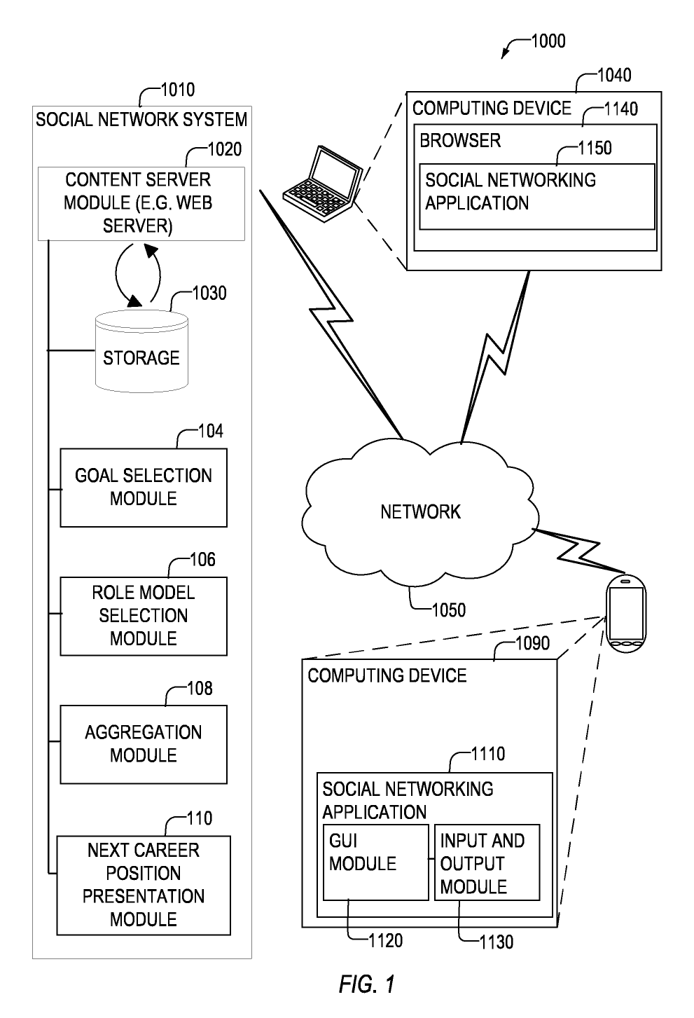

FIG. 1 shows a diagram of a social network service 1000 in accordance with some examples. Social network system 1010 may contain a content server process 1020. Content server process 1020 may communicate with storage 1030 and may communicate with one or more computing devices 1040 and 1090 through a network 1050. Content server process 1020 may be responsible for the retrieval, presentation, and maintenance of member profiles stored in storage 1030 as well as the retrieval, creation, and presentation of a user interface for users. Content server process 1020 in one example may include or be a web server that fetches or creates internet web pages. Web pages may be or include Hyper Text Markup Language (HTML), eXtensible Markup Language (XML), JavaScript, or the like. The web pages may include portions of, or all of, a member profile at the request of users 1040. The content server process 1020 may also be responsible for allowing members to communicate with one another, establish connections, and post multi-media files (e.g., pictures, videos, and the like).

Users of computing devices 1040 and 1090 may include one or more members, prospective members, or other users of the social network system 1010. Computing devices 1040 and 1090 communicate with social network system 1010 through a network 1050. The network may be any means of enabling the social network system 1010 to communicate data with computing devices 1040, 1090. Example networks 1050 may be or include portions of one or more of: the Internet, a Local Area Network (LAN), a Wide Area Network (WAN), wireless network (such as a wireless network based upon an IEEE 802.11 family of standards), a Metropolitan Area Network (MAN), a cellular network, or the like.

Computing device 1040 may be a laptop, desktop, tablet, cellphone or any other computing device which may provide a social networking application 1150 in conjunction with browser 1140. Social networking application 1150 may be one or more of hypertext markup language (HTML), javaScript, Java, or other browser executable objects that are executed within the browser 1140 to provide social networking functionality to a user. The social networking application 1150 may be deployed to the computing device 1040 by content server process 1020 through interaction with browser 1140.

Computing device 1090 may be a laptop, desktop, tablet, cellphone, or any other computing device which may provide a social networking functionality to the user through execution of a social networking application 1110. Social networking application 1110 may include a graphical user interface (GUI) module 1120 which may provide a graphical user interface output to a display which may show social networking information. Input and output module 1130 may accept input and process it in order to update the graphical user interface provided by the GUI module 1120. Input and output module 1130 may interface with the social network system 1010 through the content server process 1020 using one or more application programming interfaces (APIs). For example input and output module may receive data related to the social network system (e.g., member profile information, GUI information, and other data) by interfacing through one or more application programming interfaces (APIs).

Both social networking applications 1150 and 1110 may provide social networking functionality to users in conjunction with content server process 1020, and in some examples in conjunction with storage 1030. Social networking functionality may include viewing, editing, or deleting information in member profiles, communicating with other members, adding or removing skills, and the like.

The social network system can include various modules, connected to the content server module 1020 and storage 1030, which can prompt a user, receive input from the user, and deliver one or more recommendations of a next career position as output to the user in the form of one or more graphical user interfaces.

A goal selection module 104 can receive a goal position selected by the user. In some examples, the goal selection module 104 can include a graphical user interface that prompts the user to select a goal position as one of a plurality of system-specified goal positions. In some examples, the goal selection module 104 can include a graphical user interface that prompts the user to enter a user-specified goal position in a field on the graphical user interface.

In some examples, the goal selection module 104 is further configured to determine a current position of the user. For instance, the goal selection module 104 can include a graphical user interface that prompts the user to select a current position as one of a plurality of system-specified current positions, such as selecting a current position from a list of system-specified current positions. As another example, the goal selection module 104 can include a graphical user interface that prompts the user to enter a user-specified goal position in a field on the graphical user interface. As a further example, where the user is a member of the social network system 1010, the social network system 1010 may already include the current position of the user.

A role model selection module 106 can select a set of computer-selected role models. The computer-selected role models can be members of the social network system. In some examples, each computer-selected role model can have a career history that includes the goal position of the user.

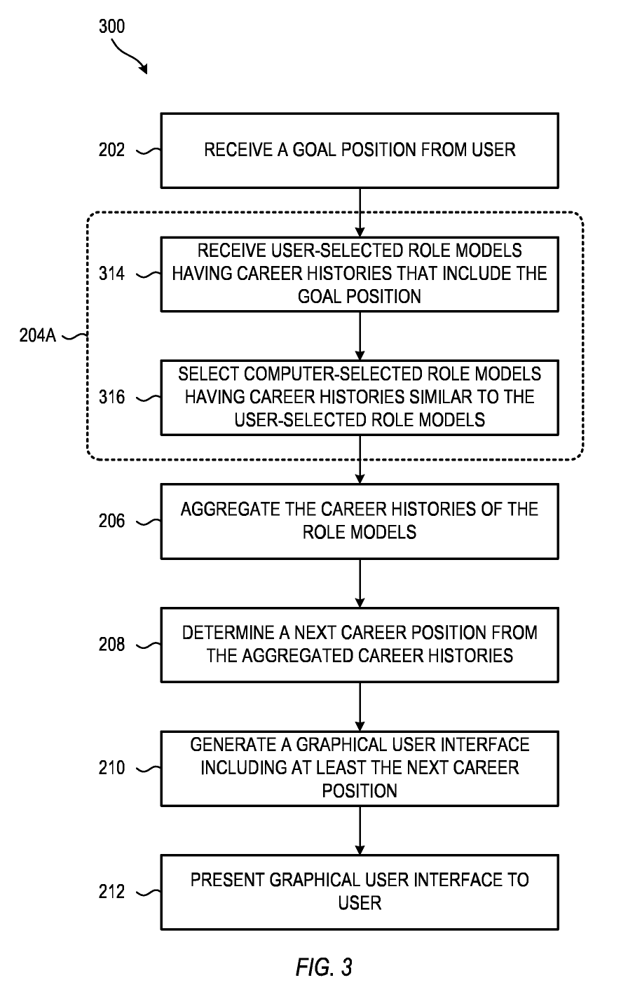

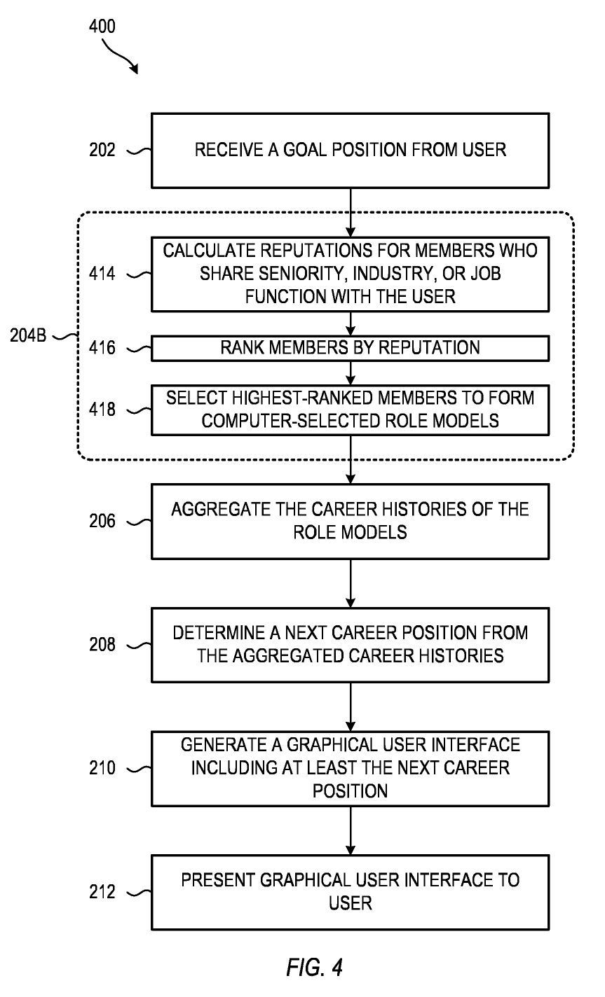

In some examples, the user selects user-selected role models, then the role model selection module 106 selects computer-selected role models based on the user-selected role models. In other examples, the role model selection module 106 selects computer-selected role without using any user-selected role models. These two options are discussed in greater detail below with respect to FIGS. 3 and 4.

In some examples, the role model selection module 106 is further configured such that at least one computer-selected role model has a career history that further includes the current position of the user. In some examples, the role model selection module 106 is further configured to receive a selection from the user of at least one user-selected role model from the members of the social network system. Each user-selected role model can have a career history that includes the goal position. In some examples, the role model selection module 106 is further configured to select the plurality of computer-selected role models from the plurality of members. Each computer-selected role model can have a career history similar to the at least one user-selected role model. The Appendix discusses in greater detail identifying similar career histories.

In some examples, the role model selection module 106 is further configured to calculate reputations for at least some members of the social network system who share at least one of seniority, industry, or job function with the user, rank the at least some members based on the reputations, and select highest-ranked members to form the set of the computer-selected role models.

An aggregation module 108 can aggregate the career histories of the computer-selected role models and determine a next career position for the user from the aggregated career histories. For example, the aggregation module 108 can determine next the career position to be the position most commonly held after a current position, en route to the goal position, for the aggregated career histories.

A next career position presentation module 110 can generate a graphical user interface including at least the next career position and present the graphical user interface to the user.

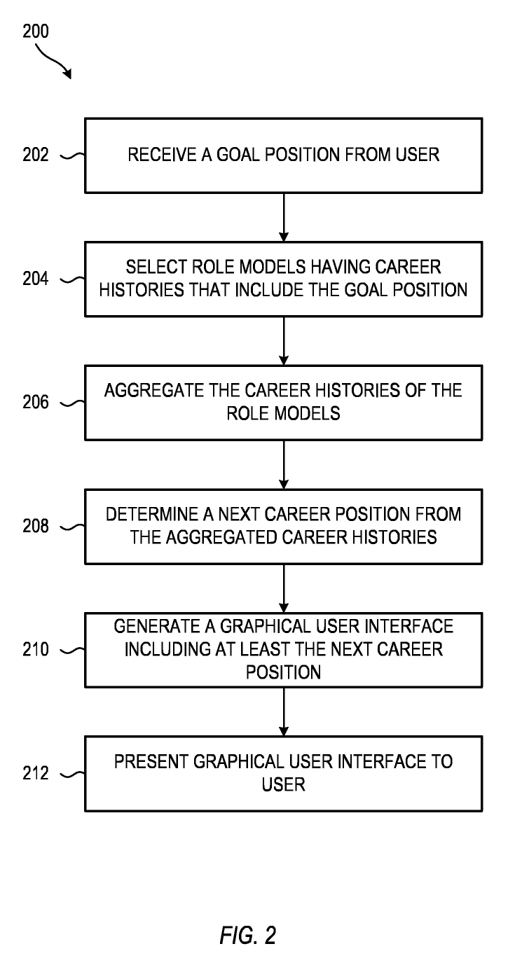

FIG. 2 shows an example of a method 200 for recommending a next career position to a user of a social network system, in accordance with some examples. The method 200 can be executed using at least one computer processor on one or more devices, such as a computer, a laptop, a smart phone, a web server, and the like. In some examples, a non-transitory machine-readable medium can include instructions, which when executed by the machine, cause the machine to perform the method 200 for recommending a next career position to a user of a social network system.

At operation 202, a user selects a goal position. The selected goal position is received by the social network system, such as through a graphical user interface.

In some examples, the goal position can be a senior job position. Examples of a senior job position can include a Senior Programmer, a Level 6 Engineer, a Patent Attorney, a Chief of Medicine, a movie Director, a radio station Program Director, a Baseball Team Manager, and other suitable positions that often require some experience at a lower position within a particular field or industry. These positions can be desirable for a user already working in a particular industry and seeking to rise within the ranks of the industry.

In some examples, the goal position can be an entry-level job position. Examples of an entry-level job position can include a Programmer, a Level 1 Engineer, a Patent Engineer, a Nursing Assistant, a movie Extra, a Disc Jockey, a Third Baseman, and other suitable positions that can often be obtained with little or no experience within a particular field or industry. These positions can be desirable for users entering the work force after a college degree, or entering a new field or industry after working in a different field or industry.

In some examples, the goal position can be a college degree. Examples of college degrees can include a Ph.D. in a particular field, a J.D., an M.D., or other suitable degrees. A user indicating a college degree as a goal may be seeking a recommendation for work experience that can improve the odds of getting into a particular program. For instance, a master's program in Nurse Anesthesia may require a particular number of years of experience as a Surgical Intensive Care Unit Nurse; a user would need this prerequisite work experience before applying to such a program.

In some examples, the user can select a goal position from a predetermined list of positions. For instance, the list of positions can be supplied by the social network system. In some examples, the list of positions can be stored as a lookup table, and can be modified or updated as needed by staff working at the social network system. In some examples, the list of positions can be generated dynamically by the social network system, using data supplied by members of the social network system. For instance, the social network system can supply a list of the most popular positions, or positions held by more than a threshold number of members. In some examples, the user interface can prompt the user using one or more questions that relate to job positions. In other examples, the user can enter a goal position through a keyboard, voice command, or other suitable user interface.

At operation 204, the system selects a set of computer-selected role models. The computer-selected role models can be members of the social network system, and may or may not be connected to the user. Each computer-selected role model can have a career history that includes the goal position of the user. In this manner, the method 200 can use information from the full membership of the social network system to find a relatively large number of members, such as 10, 100 or 500, who have actually attained the goal position in their respective careers. The method 200 can subsequently use the career histories of these members (in aggregate) to suggest a path forward for the user. Some suggestions produced by method 200 can be advantageous over those produced by a human career counselor, who might not know a large number of people in a particular job position, and might not know exactly what steps they took in their career paths to get to that job position.

In some examples, it can be advantageous to use a current position from the user, as well as the goal position of the user, to select the computer-selected role models. In some of these examples, selecting the set of computer-selected role models can include selecting at least one member that has a career history that further includes the current position of the user. In some examples, using both the current position and the goal position (rather than just the goal position) can produce more realistic suggestions for the user, since the career suggestions can arise from members who were once at the current position of the user, and eventually rose to occupy the goal position of the user. In some examples, where the user is a member of the social network system, the social network system may have access to a current position of the user, as part of the user's career history. In other examples, such as when the social network system does not have access to a current position of the user, or the user is not a member of the social network system, the method 200 can optionally receive a current position, in addition to the goal position from operation 202.

There are several ways to select the set of computer-selected role models, at operation 204. Two such examples are discussed below with regard to FIGS. 3 and 4; other ways to select the computer-selected role models can also be used.

At operation 206, the system aggregates the career histories of the computer-selected role models. As such, some details of the career histories of the computer-selected role models can be used for analysis, such as college degrees, job titles, and an ordered sequence of job titles (e.g., which job title is most likely to follow a particular job title in a career path), while the identities of the computer-selected role models may be kept private and may not presented to the user at any point.

In some examples, aggregating the career histories can produce more useful results than career advice dispensed anecdotally by a relatively small number of connections within the social network system. For example, the relatively large sample size of the aggregated career histories can show trends that may not be evident to individual members. For instance, if a user has job A and wants job G, and the aggregated career histories show that 80% of the computer-selected role models who have had job A move from job A to job B en route to job G, then such data may be more useful for the user than an anecdotal story from a member who managed to move from job A to job G without having job B.

At operation 208, the system determines a next career position for the user from the aggregated career histories. In some examples, the next career position can be the most common position sequentially held after the current position for the computer-selected role models.

Consider a specific example, where a user's current position is Programmer and the user's goal position is Chief Technical Officer. If 40% of the computer-selected role models moved from Programmer to Senior Programmer, 30% of the computer-selected role models moved from Programmer to Project Manager, 20% of the computer-selected role models moved from Programmer to Engineer, and 10% of the computer-selected role models moved from Programmer to other jobs, then operation 208 may determine that Senior Programmer is the next career position to be recommended to the user. In some examples, the system can rank the next career positions in order of most common to least common; such a ranking would present a first choice of Senior Programmer, a second choice of Project Manager, a third choice of Engineer, and so forth. It will be understood that the job titles and percentages of this specific example are presented only for the purpose of demonstration, and actual positions and percentages can vary as needed. In other examples, the next career position can be the most common position held between the current position and the goal position for the computer-selected role models.

At operation 210, the system generates a graphical user interface including at least the next career position. In some examples, the graphical user interface can include at least one of job titles, degrees, or skills held by the computer-selected role models. In some examples, the graphical user interface can include at least one of job titles, degrees, or skills held by members of the social network system having a same current position as the user.

In some examples, the graphical user interface can include trends associated with mentors or role models. Such trends can include, but are not limited to, job titles of a sample of role models, college degrees obtained by a sample of role models, skill sets held by a sample of role models, volunteer efforts contributed by a sample of role models, a ranking of companies that employ all or a subset of the role models, a ranking of colleges that have granted degrees to all or a subset of the role models, a fraction of the role models that have published within a recent time frame, and a fraction of the role models that have filed patent application within a recent time.

In some examples, the graphical user interface can include trends associated with members like the user, such as members having the same current job and/or the same current skills. Such trends can include, but are not limited to, job titles of the members like the user, college degrees obtained by the members like the user, skill sets held by the members like the user, volunteer efforts contributed by the members like the user, a ranking of companies that employ the members like the user, a ranking of colleges that have granted degrees to the members like the user, a fraction of the members like the user that have published within a recent time frame, and a fraction of the members like the user that have filed patent application within a recent time.

In some examples, the graphical user interface can include trends in the industry associated with the user. Such trends can include, but are not limited to, job title before the current job, job title after the current job, college degrees obtained before the current job, college degrees obtained after the current job, new skills, trending skills, a ranking of companies that employ members within the industry, a ranking of colleges that have granted degrees to members within the industry, and volunteer efforts contributed by members within the industry.

In some examples, the graphical user interface can include trends in demand with the industry associated with the user. Such in-demand trends can be obtained, in part, through job postings and communications with members within the industry associated with the user. Such in-demand trends can include, but are not limited to, job title before the current job, job title after the current job, college degrees obtained before the current job, college degrees obtained after the current job, skills, a ranking of companies that have job postings within the industry, a ranking of colleges by number of admissions within the industry, and volunteer efforts contributed by members within the industry.

These are but examples of data presentable by the graphical user interface. The graphical user interface can present other suitable data as well.

At operation 212, the system presents the graphical user interface to the user, such as on a web page that can be viewed on a computer, a laptop, a smart phone, or on another suitable device.

The examples described above can be implemented in one or a combination of hardware, firmware, and software. Various methods or techniques, or certain aspects or portions thereof, can take the form of program code (i.e., instructions) embodied in tangible media, such as flash memory, hard drives, portable storage devices, read-only memory (ROM), random-access memory (RAM), semiconductor memory devices (e.g., Electrically Programmable Read-Only Memory (EPROM), Electrically Erasable Programmable Read-Only Memory (EEPROM)), magnetic disk storage media, optical storage media, and any other machine-readable storage medium or storage device wherein, when the program code is loaded into and executed by a machine, such as a computer or networking device, the machine becomes an apparatus for practicing the various techniques.

A machine-readable storage medium or other storage device can include any non-transitory mechanism for storing information in a form readable by a machine (e.g., a computer). In the case of program code executing on programmable computers, the computing device can include a processor, a storage medium readable by the processor (including volatile and non-volatile memory and/or storage elements), at least one input device, and at least one output device. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

FIGS. 3 and 4 illustrate two options discussed above, with regard to generating the set of computer-selected role models, such as at operation 204 (FIG. 2). In the example of FIG. 3, the user selects user-selected role models, then the system selects computer-selected role models based on the user-selected role models. In the example of FIG. 4, the system selects computer-selected role without using any user-selected role models. These are but two examples, other suitable examples can also be used.

FIG. 3 shows an example of a method 300 for recommending a next career position to a user of a social network system, in accordance with some examples. Operations 202, 206, 208, 210, and 212 are the same operations as shown in FIG. 2. Operation 204A shows one example of an operation for selecting a set of computer-selected role models.

In operation 204A, at operation 314, a user selects one or more role models from the membership of the social network system, then the system selects one or more additional role models that have career histories similar to the user-selected role models. Allowing the user to select role models can be useful if the user personally knows a member that has already achieved the goal position, such as a co-worker or a mentor.

Operation 314 can include presenting an input graphical user interface to the user. In some examples, the input graphical user interface can limit the at least one user-selected role model to members of the social network system that are connected to the user.

Operation 314 can include receiving a selection from the user of at least one user-selected role model from the members of the social network system. For example, the system can display a graphical user interface to the user. The graphical user interface can include a list of connections to the user, where the list is formed from connections that have a career history that includes the goal position. The graphical user interface can receive a selection of one or more connections from the list. The selected connections can form the user-selected role models. This is but one example; other examples can be used. For instance, the graphical user interface can allow a user to select any member to be a user-selected role model, where the member may or may not be connected to the user. The graphical user interface can ensure that each user-selected role model can have a career history that includes the goal position.

In operation 204A, at operation 316, the system can select the plurality of computer-selected role models from the plurality of members. The computer-selected role models can be selected such that each computer-selected role model can have a career history similar to the at least one user-selected role model. In some examples, the set of computer-selected role model can include none, at least one, or all of the user-selected role models.

In operation 316, the system can select the set of computer-selected role models such that computer-selected role models are greater in number than the at least one user-selected role model. This can advantageously increase a sample size of career histories beyond a number of connections held by the user.

In operation 316, the system can optionally use the current position of the user, in addition to the goal position, to select the computer-selected role models. For instance, operation 314 can optionally include presenting an input graphical user interface to the user. The input graphical user interface can limit the at least one user-selected role model to members of the social network system that have a career history that includes the current position of the user.

FIG. 4 shows another example of a method 400 for recommending a next career position to a user of a social network system, in accordance with some examples. Operations 202, 206, 208, 210, and 212 are the same operations as shown in FIG. 2. Operation 204B shows another example of an operation for selecting a set of computer-selected role models.

In operation 204B, the system can select one or more additional role models without requiring the user to select role models.

In operation 204B, operation 414 can include calculating reputations for at least some members of the social network system who share at least one of seniority, industry, or job function with the user. In some examples, each reputation can be calculated based in part on at least one of years of experience in the industry, published articles, or feedback from other members. For example, the system can rate the members for each of several categories (such as years of experience, number of published articles, number of positive comments from other members), and can weight the ratings in the respective categories to form the reputation. This is but one example; other suitable examples can also be used.

In operation 204B, operation 416 can include ranking the at least some members based on the reputations.

In operation 204B, operation 418 can include selecting highest-ranked members to form the set of the computer-selected role models.

In some examples, a system can combine features from operations 204A (FIG. 3) and 204B (FIG. 4). For instance, a system can receive user-selected role models from the user, can select the computer-selected role models, can calculate reputations for the computer-selected role models, can rank the computer-selected role models by reputation, and can select the highest-ranked of the computer-selected role models to use for subsequent aggregation. In some examples, a system can select some of the computer-selected role models using operation 204A (FIG. 3), and others of the computer-selected role models using operation 204B (FIG. 4).

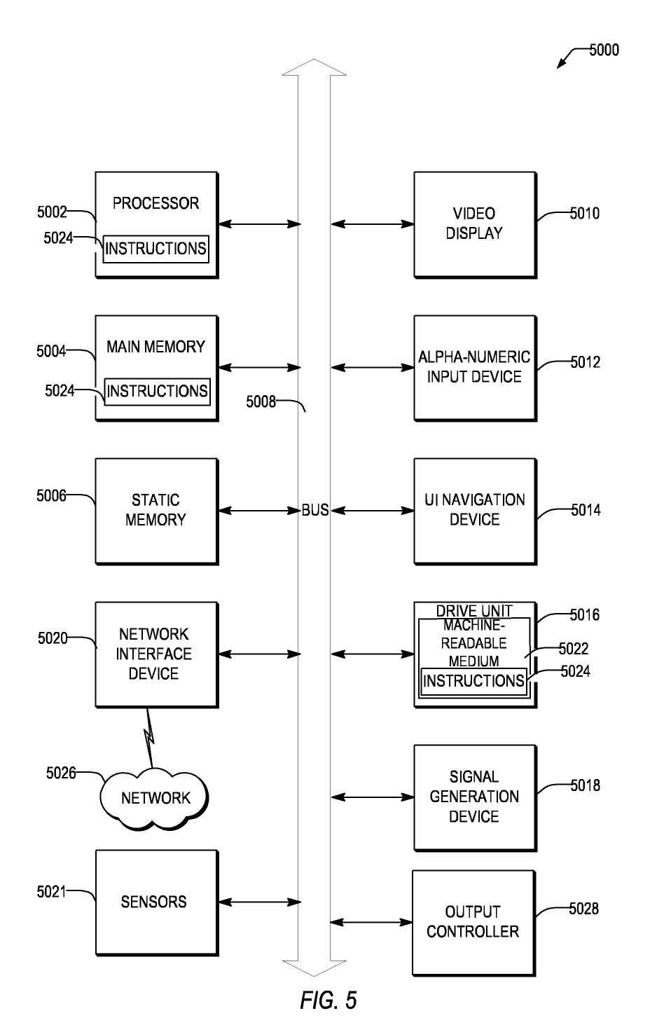

FIG. 5 illustrates a block diagram of an example machine 5000 upon which any one or more of the techniques (e.g., methodologies) discussed herein may perform. The components of FIG. 8 may execute upon and/or include one or more of the components in FIG. 5. In alternative examples, the machine 5000 may operate as a standalone device or may be connected (e.g., networked) to other machines. In a networked deployment, the machine 5000 may operate in the capacity of a server machine, a client machine, or both in server-client network environments. In an example, the machine 5000 may act as a peer machine in peer-to-peer (P2P) (or other distributed) network environment. The machine 5000 may be a server, personal computer (PC), a tablet PC, a set-top box (STB), a personal digital assistant (PDA), a mobile telephone, a smart phone, a web appliance, a network router, switch or bridge, a component of a social networking service, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 5000 may include a hardware processor 5002 (e.g., a central processing unit (CPU), a graphics processing unit (GPU), a hardware processor core, or any combination thereof), a main memory 5004 and a static memory 5006, some or all of which may communicate with each other via an interlink (e.g., bus) 5008. The machine 5000 may further include a display unit 5010, an alphanumeric input device 5012 (e.g., a keyboard), and a user interface (UI) navigation device 5014 (e.g., a mouse). In an example, the display unit 5010, input device 5012 and UI navigation device 5014 may be a touch screen display. The machine 5000 may additionally include a storage device (e.g., drive unit) 5016, a signal generation device 5018 (e.g., a speaker), a network interface device 5020, and one or more sensors 5021, such as a global positioning system (GPS) sensor, compass, accelerometer, or other sensor. The machine 5000 may include an output controller 5028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 5016 may include a machine readable medium 5022 on which is stored one or more sets of data structures or instructions 5024 (e.g., software) embodying or utilized by any one or more of the techniques or functions described herein. The instructions 5024 may also reside, completely or at least partially, within the main memory 5004, within static memory 5006, or within the hardware processor 5002 during execution thereof by the machine 5000. In an example, one or any combination of the hardware processor 5002, the main memory 5004, the static memory 5006, or the storage device 5016 may constitute machine readable media.

While the machine readable medium 5022 is illustrated as a single medium, the term “machine readable medium” may include a single medium or multiple media (e.g., a centralized or distributed database, and/or associated caches and servers) configured to store the one or more instructions 5024.

The term “machine readable medium” may include any medium that is capable of storing, encoding, or carrying instructions for execution by the machine 5000 and that cause the machine 5000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 5024 may further be transmitted or received over a communications network 5026 using a transmission medium via the network interface device 5020. The Machine 5000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 5020 may include one or more physical jacks (e.g., Ethernet, coaxial, or phone jacks) or one or more antennas to connect to the communications network 5026. In an example, the network interface device 5020 may include a plurality of antennas to wirelessly communicate using at least one of single-input multiple-output (SIMO), multiple-input multiple-output (MIMO), or multiple-input single-output (MISO) techniques. In some examples, the network interface device 5020 may wirelessly communicate using Multiple User MIMO techniques.

Appendix

As discussed above, a system can select a computer-selected role model that has career history similar to that of a user-selected role model. In some examples, the system can deem two career histories as being similar if they coincide on at least two positions within the career histories. In other examples, the definition of similar can be more sophisticated.

For instance, U.S. patent application Ser. No. 13/194,883, filed on Jul. 29, 2011, titled “Methods And Systems For Identifying Similar People Via A Business Networking Service”, and published on Jan. 31, 2013 as U.S. Patent Application Publication No. US-2013-0031090-A1, discusses a technique within a social networking service that can compare two member profiles and decide if they are similar, based on various criteria. The '883 application is hereby incorporated by reference in its entirety. In some examples, a user employing such a technique can be referred to as finding “People Like Me”. The technique from the '883 application is presented in detail below.

Consistent with recommendation technique discussed in the '883 application, and as described in detail herein, a social or business networking service includes the necessary logic to identify member profiles that are similar to a given member profile. For purposes of the present disclosure, the given member profile, which serves as input to a member profile matching algorithm or process, is referred to herein as a “source member profile.” To distinguish from the source member profile, the member profiles that are determined to be similar to the source member profile are referred to herein as “target member profiles.” The ability to accurately identify target member profiles similar to a source member profile will find practical application in a great number of scenarios. In some applications, a user may select the source member profile, and the target member profiles may then be identified and presented to the user. For example, upon receiving a request to present member profiles similar to another particular source member profile, the social networking service will, in real-time, analyze a variety of member profiles to select the particular target member profiles that have the highest similarity scores with respect to the source member profile. After identifying the most similar member profiles (e.g., those with the highest similarity scores), the social networking service may present the viewer who initiated the request with a list of a number of selected target member profiles. In some instances, the list will be presented with member profile summaries, which, if selected, will cause a detailed view of the selected member profile to be presented. In addition, with some examples, the requesting viewer may filter or further refine the list of member profiles by specifying various profile features as filter criteria and/or sort criteria, and so forth.

In some applications, the source member profile may be selected, not by a user, but by an application or process. For example, with some examples, an application or process may select a source member profile because the source member profile has certain characteristics. For instance, a group recommendation service or feature may recommend to members of the social networking service that they join particular groups hosted by the social networking service that are likely to be of interest to the social networking service members, based on the fact that the members have member profiles that are similar to a model member profile generated based on an analysis of the member profiles of all members in the group. Accordingly, a source member profile may be generated based on the aggregate member profile information of all members common to the group. The recommendation service may then select this source member profile as an input to the member profile matching algorithm, and identify target member profiles that are similar to the model source member profile for the group. For each target member profile that is determined to be similar to the selected source member profile for a particular group, the recommendation service may recommend to a member having a member profile similar to that model profile for that group, that the member join the group if not already a member of the group.

As will be described in greater detail below, with some examples, the ability to accurately identify in real-time a set of member profiles most similar to a source member profile is achieved with a general recommendation engine. Accordingly, at least with some examples, the recommendation engine provides a recommendation service that can be customized for use with a great number of applications or services. For instance, in addition to identifying similarities between different member profiles, the recommendation engine can be configured to process other recommendation entity types to identify similarities between the recommendation entities. For purposes of the present disclosure, a recommendation entity is simply a collection of information organized around a particular concept that is supported by the social networking service in general, and the recommendation engine in particular. For instance, some examples of recommendation entities are: member profiles, jobs or job listings, interest groups, companies, advertisements, events, news, discussions, tweets, questions and answers, and so forth. Accordingly, with some examples, by specifying the particular features of two recommendation entities to be compared, and by specifying a particular algorithm for use in generating a similarity score for the two recommendation entities, the recommendation engine can be configured and customized to perform such tasks as: generate similarity scores for use in recommending job listings to a member; generate similarity scores for use in recommending particular interest groups that a user might be interested in joining; generate similarity scores for use in displaying an appropriate or relevant advertisement to a particular member, and many others.

In general, the recommendation engine operates in two phases. In the first phase, the data representing each individual instance of a particular recommendation entity (e.g., a member profile, a job listing, a group, and so forth) is processed by a feature extraction engine to extract the relevant features on which matching analysis is to be performed. For instance, in the case of a member profile, only certain portions of a member's profile (referred to herein as features) may be selected for use in determining the similarity of any two member profiles. As such, during the first phase, a feature extraction engine processes each member profile to extract the relevant profile features from each member profile. In addition to simply extracting certain features from relevant recommendation entities, the feature extraction engine may derive certain features based on other information included in the recommendation entity (e.g., member profile). Continuing with the example of member profiles, one feature that may be used to identify similar member profiles is work experience, measured in the number of years since a member graduated from school. While this number is not typically included as raw data in a member's profile, it may be derived with a simple calculation if the member's graduation date is specified in the member's profile. In addition, with some examples, the feature extraction engine may standardize and/or normalize various features, such as a member's job or position title, or, the name of a company at which a member has indicated being employed. With some examples, certain profile features may be retrieved from external data sources, using other information included in the recommendation entity as part of a query to the external data source.

The first phase may occur in real-time or in the background (e.g., offline, as part of a batch process), and in some examples, due to the large amounts of data being processed, is achieved via a parallel or distributed computing platform. Once the relevant features have been extracted, computed, derived, or retrieved, for each recommendation entity, these relevant features are stored as a pre-processed recommendation entity. For instance, in the case of a member profile, the feature extraction process results in an enhanced member profile that includes only the relevant features extracted from a member's profile as well as any derived or retrieved profile features. This pre-processed enhanced profile is used during the recommendation engine's second phase, when the matching engine compares the relevant profile features for one member against each target member profile until those member profiles with the highest similarity scores are identified. For example, during the second phase, the matching engine of the recommendation engine uses a configuration file that is customized for the particular analysis being performed. For example, a first configuration file (referred to herein as a profile matching configuration file) may exist for use in identifying member profiles similar to a source member profile, whereas a second configuration file—specifying different features from different recommendation entities to be compared, and a different algorithm for computing the matching scores—may be specified for determining the job listings that are most likely to be of interest to a particular member. As such, by configuring the feature extraction engine to extract relevant data from certain recommendation entities, and customizing the analysis performed by the matching engine with an appropriate configuration file, a wide variety of recommendation operations can be achieved with the general recommendation engine.

An example of a computer-implemented method for identifying member profiles similar to a source member profile follows. A request can be received to present a list of member profiles similar to a first member profile. Each member profile can be for a member of a social networking service. Similarity scores can be determined for each of a plurality of member profiles, optionally in real time. The similarity score for each of the plurality of member profiles can indicate a measure of similarity between the respective member profile and the first member profile. The similarity score for each member profile of the plurality of member profiles can be determined by retrieving a set of profile features from an enhanced member profile corresponding with a respective member profile. The enhanced member profile can include profile features extracted from the member profile and enhanced profile features that have been derived based on data in the member profile or retrieved from a data source external to the social networking service. The similarity score can be determined by further comparing each profile feature in the set of profile features with a corresponding profile feature from the first member profile to derive a similarity sub-score for each profile feature in the set. The similarity score can be determined by further combining the similarity sub-scores corresponding with each profile feature in the set of profile features to derive the similarity score for the member profile. A number of member profiles having the highest similarity scores in relation to the first member profile can be presented. This is but one example; other examples can also be used.

What is claimed is:

1. A method for recommending a next career position to a user of a social network system, the method comprising:
using at least one computer processor to:
receive a goal position selected by the user;
select a set of computer-selected role models, the computer-selected role models being members of the social network system, each computer-selected role model having a career history that includes the goal position of the user;
aggregate the career histories of the computer-selected role models;
determine a next career position for the user from the aggregated career histories;
generate a graphical user interface including at least the next career position; and
present the graphical user interface to the user.

2. The method of claim 1,
further comprising using the at least one computer processor to determine a current position of the user;
wherein selecting the set of computer-selected role models comprises selecting at least one member that has a career history that further includes the current position of the user.

3. The method of claim 1, wherein selecting the set of computer-selected role models comprises:
receiving a selection from the user of at least one user-selected role model from the members of the social network system, each user-selected role model having a career history that includes the goal position; and
selecting the plurality of computer-selected role models from the plurality of members, each computer-selected role model having a career history similar to the at least one user-selected role model.

4. The method of claim 3, wherein the at least one computer processor selects the set of computer-selected role models such that computer-selected role models are greater in number than the at least one user-selected role model.

5. The method of claim 3, wherein receiving the selection from the user of at least one user-selected role model from the members of the social network system comprises:
presenting an input graphical user interface to the user, the input graphical user interface limiting the at least one user-selected role model to members of the social network system that are connected to the user.

6. The method of claim 3,
further comprising using the one or more computer processors to determine a current position of the user; and
wherein receiving a selection from the user of at least one user-selected role model from the members of the social network system comprises:
presenting an input graphical user interface to the user, the input graphical user interface limiting the at least one user-selected role model to members of the social network system that have a career history that includes the current position of the user.

7. The method of claim 1, wherein selecting the set of computer-selected role models comprises:
calculating reputations for at least some members of the social network system who share at least one of seniority, industry, or job function with the user;
ranking the at least some members based on the reputations; and
selecting highest-ranked members to form the set of the computer-selected role models.

8. The method of claim 7, wherein each reputation is calculated based in part on at least one of years of experience in the industry, published articles, or feedback from other members.

9. The method of claim 1, wherein generating the graphical user interface including at least the next career position comprises including on the graphical user interface at least one of job titles, degrees, or skills held by the computer-selected role models.

10. The method of claim 1, wherein generating the graphical user interface including at least the next career position comprises including on the graphical user interface at least one of job titles, degrees, or skills held by members of the social network system having a same current position as the user.

11. The method of claim 1, wherein the selected goal position is one of a senior job position, an entry-level job position, or a college degree.

12. The method of claim 1, wherein the next career position is the most common position sequentially held after the current position for the computer-selected role models.

13. A social network system for recommending a next career position to a user of a social network system, the system comprising:
at least one processor; and
memory, including instructions that, when executed on the at least one processor, cause the at least one processor to:
receive a goal position selected by the user;
select a set of computer-selected role models, the computer-selected role models being members of the social network system, each computer-selected role model having a career history that includes the goal position of the user;
aggregate the career histories of the computer-selected role models;
determine a next career position for the user from the aggregated career histories;
generate a graphical user interface including at least the next career position; and
present the graphical user interface to the user.

14. The system of claim 13,
wherein the instructions further cause the at least one processor to determine a current position of the user; and
wherein selecting the set of computer-selected role models comprises selecting at least one member that has a career history that further includes the current position of the user.

15. The system of claim 13, wherein selecting the set of computer-selected role models comprises:
receiving a selection from the user of at least one user-selected role model from the members of the social network system, each user-selected role model having a career history that includes the goal position; and
selecting the plurality of computer-selected role models from the plurality of members, each computer-selected role model having a career history similar to the at least one user-selected role model.

16. The system of claim 13, wherein selecting the set of computer-selected role models comprises:
calculating reputations for at least some members of the social network system who share at least one of seniority, industry, or job function with the user;
ranking the at least some members based on the reputations; and
selecting highest-ranked members to form the set of the computer-selected role models.

17. A non-transitory machine-readable medium, including instructions, which when executed by the machine, cause the machine to perform operations for recommending a next career position to a user of a social network system, the operations comprising:
receiving a goal position selected by the user;
selecting a set of computer-selected role models, the computer-selected role models being members of the social network system, each computer-selected role model having a career history that includes the goal position of the user;
aggregating the career histories of the computer-selected role models;
determining a next career position for the user from the aggregated career histories;
generating a graphical user interface including at least the next career position; and
presenting the graphical user interface to the user.

18. The machine-readable medium of claim 17,
wherein the operations further comprise determining a current position of the user; and
wherein selecting the set of computer-selected role models comprises selecting at least one member that has a career history that further includes the current position of the user.

19. The machine-readable medium of claim 17, wherein selecting the set of computer-selected role models comprises:
receiving a selection from the user of at least one user-selected role model from the members of the social network system, each user-selected role model having a career history that includes the goal position; and
selecting the plurality of computer-selected role models from the plurality of members, each computer-selected role model having a career history similar to the at least one user-selected role model.

20. The machine-readable medium of claim 17, wherein selecting the set of computer-selected role models comprises:
calculating reputations for at least some members of the social network system who share at least one of seniority, industry, or job function with the user;
ranking the at least some members based on the reputations; and
selecting highest-ranked members to form the set of the computer-selected role models.
